(19) United States
(12) Patent Application Publication
(10) Pub. No.: US 2023/0401361 A1
(43) Pub. Date: Dec. 14, 2023

(54) GENERATING AND ANALYZING MATERIAL STRUCTURES BASED ON NEURAL NETWORKS

(71) Applicant: VOLKSWAGEN AKTIENGESELLSCHAFT, WOLFSBURG (DE)

(72) Inventors: Wesley Teskey, Foster City, CA (US); Gianina Alina Negoita, Belmont, CA (US)

(21) Appl. No.: 17/835,838

(22) Filed: Jun. 8, 2022

(51) Int. Cl. G06F 30/27; G06F 30/23; G06N 3/04

(52) U.S. Cl. CPC G06F 30/27; G06F 30/23; G06N 3/04; G06F 2119/02

(57) ABSTRACT

In one embodiment, a method is provided. The method includes obtaining a set of graphs for a set of material structures. Each graph of the set of graphs is associated with a material structure of the set of material structures. The method also includes determining first sets of stress values and first sets of strain values for the set of graphs based on a neural network. The method further includes obtaining second sets of stress value and second sets of strain values for a subset of the set of material structures. The method further includes updating the neural network based on the first sets of stress values, the first sets of strain values, the second sets of stress values, and the second sets of strain values.

### TECHNICAL FIELD

Aspects of the present disclosure relate to generating and analyzing material structures, and more particularly, to generating and analyzing material structures based on neural networks.

### BACKGROUND

Various different materials (e.g., metals, alloys, polymers, ceramics, composites, etc.) can be used for various different purposes and/or applications. For example, a material may be used in as a casing or enclosure for a battery (e.g., a casing for an electric vehicle (EV) battery). All materials have a material structure. The material structure may be the physical structure and/or arrangements of the components of a material (or the components of multiple materials for composite materials).

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a block diagram that illustrates an example system architecture, in accordance with one or more embodiments of the present disclosure.

FIG. 2 is a diagram illustrating an example material generation system, in accordance with one or more embodiments of the present disclosure.

FIG. 3 is a diagram illustrating an example material generation system, in accordance with one or more embodiments of the present disclosure.

FIG. 4 is a diagram illustrating an example material structure, in accordance with one or more embodiments of the present disclosure.

FIG. 5 is a diagram illustrating an example graph, in accordance with one or more embodiments of the present disclosure.

FIG. 6 is a diagram illustrating example material structures, in accordance with one or more embodiments of the present disclosure.

FIG. 7 is a flow diagram of a process for generating material structures, in accordance with one or more embodiments of the present disclosure.

FIG. 8 is a block diagram of an example computing device that may perform one or more of the operations described herein, in accordance with some embodiments of the present disclosure.

### DETAILED DESCRIPTION

As discussed above, all materials (e.g., metals, alloys, polymers, ceramics, composites, etc.) have a structure (e.g., a material structure). The material structure may be the physical structure and/or arrangements of the components of a material (or the components of multiple materials for composite materials). The structure of a material (such as metals, polymers, ceramics or composites) may influence and/or affect various properties of the material (e.g., physical properties, chemical properties, etc.). Such properties may include an amount of stress and/or strain that the material can accommodate, strength, toughness, corrosion resistance, high/low temperature behavior, ductility, hardness, wear resistance, etc.

Creating, generating, constructing, etc., a new material structure is often a manual process performed by specialists/experts. For example, generating a new material structure is typically done via experimentation and/or finite element analysis (FEA). Thus generating new material structures may be a challenging and/or expensive process. In addition, generating new material structure is a time consuming process, which makes it even more difficult to generate and test out new materials quickly within a given time period. For example, experimentation and performing FEA analysis may take days, months, or even years.

The examples, implementations, and embodiments described herein may help address these issues, among others, when determining the properties of various materials (e.g., material properties). In one embodiment, a material generation system generates new material structures based on an initial set of material structures (e.g., by adding or removing portions of material). The material generation system may analyze the new material structures using a machine learning model, to determine stress/stain values for the new material structures. A subset of the new material structures may be selected based on their stress/stain values and finite element analysis may be performed on that subset of material structures. The stress/stain values determined using the FEA may be used to retrain or update the machine learning model to improve the accuracy/performance of the machine learning model when determining stress/stain values.

In one embodiment, the material generation system may simplify or streamline the process of generating, creating, designing, etc., new material structures. For example, rather than using only a manual experimentation process and finite element analysis (FEA) performed by experts/specialists, the material generation system may apply machine learning models to analyze or evaluate new material structures more quickly, efficiently, etc., when compared with manual experimentation or using FEA. By generating new material structures and analyzing/evaluating the material structures using a machine learning model, the material generation system may generate new material structures much more quickly, efficiently, and with less expense than previous processes/methods for creating new material structures.

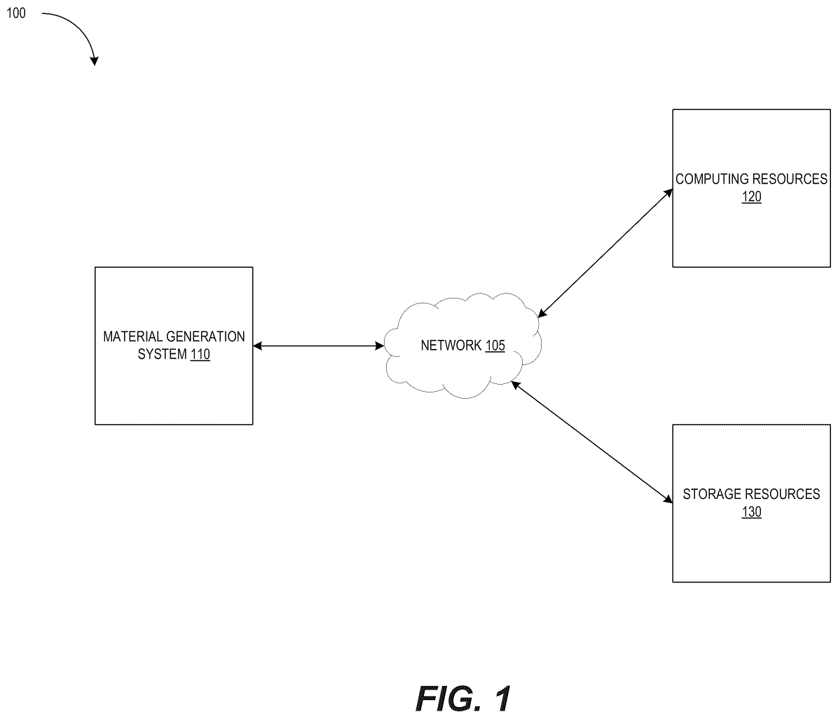

FIG. 1 is a block diagram that illustrates an example system architecture 100, in accordance with some embodiments of the present disclosure. The system architecture 100 includes network 105, a material generation system 110, computing resources 120, and storage resources 130. Network 105 may interconnect the material generation system 110, the computing resources 120, and/or the storage resources 130. Network 105 may be a public network (e.g., the internet), a private network (e.g., a local area network (LAN) or wide area network (WAN)), or a combination thereof. In one embodiment, network 105 may include a wired or a wireless infrastructure, which may be provided by one or more wireless communications systems, such as a wireless fidelity (Wi-Fi) hotspot connected with the network, a cellular system, and/or a wireless carrier system that can be implemented using various data processing equipment, communication towers (e.g. cell towers), etc. Network 105 may carry communications (e.g., data, message, packets, frames, etc.) between the material generation system 110, the computing resources 120 and/or the storage resources 130.

The computing resources 120 may include computing devices which may include hardware such as processing devices (e.g., processors, central processing units (CPUs), processing cores, graphics processing units (GPUS)), memory (e.g., random access memory (RAM), storage devices (e.g., hard-disk drive (HDD), solid-state drive (SSD), etc.), and other hardware devices (e.g., sound card, video card, etc.). The computing devices may comprise any suitable type of computing device or machine that has a programmable processor including, for example, server computers, desktop computers, rackmount servers, etc. In some examples, the computing devices may include a single machine or may include multiple interconnected machines (e.g., multiple servers configured in a cluster, cloud computing resources, etc.).

The computing resources 120 may also include virtual environments. In one embodiment, a virtual environment may be a virtual machine (VM) that may execute on a hypervisor which executes on top of the OS for a computing device. The hypervisor may also be referred to as a virtual machine monitor (VMM). A VM may be a software implementation of a machine (e.g., a software implementation of a computing device) that includes its own operating system (referred to as a guest OS) and executes application programs, applications, software. The hypervisor may be a component of an OS for a computing device, may run on top of the OS for a computing device, or may run directly on host hardware without the use of an OS. The hypervisor may manage system resources, including access to hardware devices such as physical processing devices (e.g., processors, CPUs, etc.), physical memory (e.g., RAM), storage device (e.g., HDDs, SSDs), and/or other devices (e.g., sound cards, video cards, etc.). The hypervisor may also emulate the hardware (or other physical resources) which may be used by the VMs to execute software/applications. The hypervisor may present other software (i.e., “guest” software) the abstraction of one or more virtual machines (VMs) that provide the same or different abstractions to various guest software (e.g., guest operating system, guest applications). A VM may execute guest software that uses an underlying emulation of the physical resources (e.g., virtual processors and guest memory).

In another embodiment, a virtual environment may be a container that may execute on a container engine which executes on top of the OS for a computing device, as discussed in more detail below. A container may be an isolated set of resources allocated to executing an application, software, and/or process independent from other applications, software, and/or processes. The host OS (e.g., an OS of the computing device) may use namespaces to isolate the resources of the containers from each other. A container may also be a virtualized object similar to virtual machines. However, a container may not implement separate guest OS (like a VM). The container may share the kernel, libraries, and binaries of the host OS with other containers that are executing on the computing device. The container engine may allow different containers to share the host OS (e.g., the OS kernel, binaries, libraries, etc.) of a computing device. The container engine may also facilitate interactions between the container and the resources of the computing device. The container engine may also be used to create, remove, and manage containers.

The storage resources 130 may include various different types of storage devices, such as hard disk drives (HDDs), solid state drives (SSD), hybrid drives, storage area networks, storage arrays, etc. The storage resources 130 may also include cloud storage resources or platforms which allow for dynamic scaling of storage space.

Although the computing resources 120 and the storage resources 130 are illustrated separate from the material generation system 110, one or more of the computing resources 120 and the storage resources 130 may be part of the material generation system 110 in other embodiments. For example, the material generation system 110 may include both the computing resources 120 and the storage resources 130.

As discussed above, generating, creating, developing, etc., new material structures may be a challenging, time consuming, and/or expensive process that is often performed manually by experts/specialists. The examples, implementations, and embodiments described herein may help address these issues by using machine learning models to determine the stress values and/or strain values for material structures (e.g., to analyze or evaluate material structures).

The generation and analysis of new material structures (e.g., determining stress/strain values) may be performed much more quickly when compared with only using finite element analysis (FEA) and/or experimentation (e.g., real or physical experimentation). For example, rather than generating and analyzing tens of new materials with FEA within a time period, material generation system 110 may be able to generate and analyze thousands or millions of different new material structures within the same time period. This may allow new materials to be developed, created, etc., more quickly and efficiently.

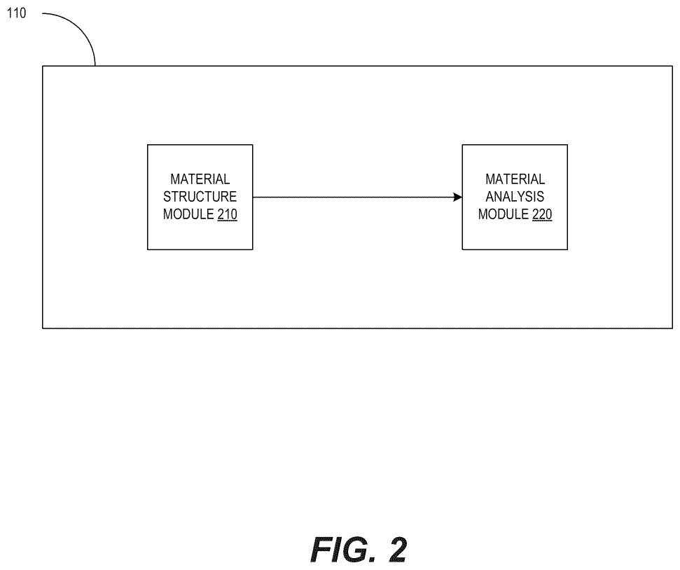

FIG. 2 is a diagram illustrating an example material generation system 110, in accordance with one or more embodiments of the present disclosure. The material generation system 110 includes a material structure module 210 and a material analysis module 220. Each of the material structure module 210 and the material analysis module 220 may be a combination of hardware, software, and firmware. In addition, any of the material structure module 210 and the material analysis module 220 may be distributed over multiple computing devices.

In one embodiment, the material structure module 210 may obtain (e.g., receive, retrieve, access, etc.) a set of initial material structures. For example, the material structure module 210 may be received from a user of the material generation system 110. In another example, the set of initial material structures may have been previously generated by the material generation system 110.

In one embodiment, the material structure module 210 may generate a set of material structures based on the initial set of material structures. The set of material structures generated by the material structure module 210 (e.g., the set of graphs that represent the material structures) may be referred to as possible material structures, candidate material structures, etc. The material structure module 210 may generate the set of material structures by modifying one or more of the initial set of material structures. For example, the material structure module 210 may modify graphs (or other data structures representing material structures) of the initial set of material structures to indicate/represent modifications to the initial set of material structures.

In one embodiment, the initial set of material structures may be associated with initial sets of stress values and initial sets of strain values. For example, each initial material structure (of the initial set of material structures) may have determined (e.g., previously known, calculated, computed, solved, etc.) stress/strain values. A stress value may indicate an amount of stress that is present at a particular finite element of a material structure. A strain value may indicate an amount of strain that is present at a particular finite element of a material structure.

In one embodiment, the material structure module 210 may generate the set of material structures (e.g., one or more material structures) by removing material (e.g., portions of material) from the initial set of material structures. For example, the material structure module 210 may use a first initial material structure (of the initial set of material structures) and may remove one or more portions of material from the first initial material structure to generate a first material structure (of the set of material structures). The material structure module 210 may further generate additional material structures by removing portions of material from other initial material structures. As discussed above, the material structure module 210 may remove portions of material from an initial material structure by removing nodes and/or edges from a graph that represents the initial structure. The resulting graph (with one or more nodes and/or edges removed) may represent a new material structure.

In one embodiment, the material structure module 210 may remove material from areas of the initial set of material structures with stress values below a threshold stress value and/or below a threshold strain value. As discussed above, each finite element (e.g., portion/area) of the first initial material structure may have (e.g., may be associated with) a corresponding stress value and a corresponding strain value. The material structure module 210 may remove material from a portion/area of the first initial material structure (e.g., a finite element or a portion of a finite element) if the stress value for the portion/area of the first initial material structure is below a threshold stress value and/or if the strain value for the portion/area of the first initial material structure is below a threshold strain value. For example, the material structure module 210 may remove nodes from the graph (that represents a material structure) where the removed nodes represent finite elements with stress values and/or strain values below one or more threshold values. The threshold strain value and/or the threshold stress value may vary in different embodiments.

In one embodiment, the material structure module 210 may generate the set of material structures (e.g., one or more material structures) by adding material (e.g., portions of material) to the initial set of material structures. For example, the material structure module 210 may use a first initial material structure (of the initial set of material structures) and may add one or more portions of material to the first initial material structure to generate a first material structure (of the set of material structures). The material structure module 210 may further generate additional material structures by adding portions of material to other initial material structures. As discussed above, the material structure module 210 may add portions of material to an initial material structure by adding nodes and/or edges to a graph that represents the initial structure. The resulting graph (with one or more added nodes and/or added edges) may represent a new material structure.

In one embodiment, the material structure module 210 may add material to areas of the initial set of material structures with stress values and strain values above one or more threshold values (e.g., a threshold strain value and/or a threshold stress value). As discussed above, each finite element (e.g., portion/area) of the first initial material structure may have (e.g., may be associated with) a corresponding stress value and a corresponding strain value. The material structure module 210 may add material to a portion/area of the first initial material structure (e.g., a finite element or a portion of a finite element) if the stress value for the portion/area of the first initial material structure is above a threshold stress value and/or if the strain value for the portion/area of the first initial material structure is above a threshold strain value. For example, the material structure module 210 may add nodes and/or edges to the graph (that represents a material structure) where the added nodes represent finite elements with stress values and/or strain values above one or more threshold values. The added edges may represent new adjacencies between the newly added nodes, or between newly added nodes and existing nodes. The threshold strain value and/or the threshold stress value may vary in different embodiments.

In one embodiment, the material structure module 210 may generate the set of material structures (e.g., one or more material structures) by repositioning (e.g., moving, relocating, displacing, etc.) portions of the material in the initial set of material structures. For example, the material structure module 210 may move a node in a graph for a first initial material structure to a different location in the graph, to generate a new or updated graph for a new material structure. The material structure module 210 may move one or more nodes by updating the location (e.g., XYZ coordinates) for the one or more nodes (e.g., by updating coordinates stored within the nodes or in an associated data structure, as discussed in more detail below). The node may be moved to a location that is farther away from one or more other nodes or to a location that is closer to one or more other nodes.

In one embodiment, the material structure module 210 may obtain a set of graphs for the material structures (that were generated by the material structure module 210). For example, the material structure module 210 access/retrieve the set of graphs from a data store (e.g., a memory, flash drive, hard drive, cloud storage, etc.). The set of graphs for the material structures may have been generated based on an initial set of graphs for an initial set of material structures, as discussed above. Each graph is associated with the corresponding material structure. Each graph may also be referred to as a representation of a material structure. For example, modifications to a graph may represent or indicate modifications to the corresponding material structure. Although the present disclosure may refer to a graph or graphs, other data structures and/or data formats may be used to represent material structures in other embodiments. For example, tables, lists, etc., may be used to represent material structures. The graphs and other data structures/formats may be modified to reposition, add, and/or remove portions of a material structure, resulting in a new material structure.

In one embodiment, a graph (for a material structure) may include nodes and edges that interconnect the nodes. Each node in the graph may represent a finite element (e.g., a portion/area) of the corresponding material structure. A node in the graph may be connected to one or more other nodes via an edge if the finite element represent by the node is adjacent to other finite elements within the material structure. For example, if a first finite element is adjacent to (e.g., connected to, coupled to, etc.) another a second finite element, the graph may include an edge between a first node (representing the first finite element) and a second node (representing the second finite element). Graphs for material structures are discussed in more detail below.

In one embodiment, the material analysis module 220 may determine a set of stress values and/or a set of strain values for each graph (that represents a corresponding material structure generated by the material structure module 210). For example, the material analysis module 220 may include and/or may use a machine learning model, such as a neural network, to determine a set of stress values and/or a set of strain values for each graph. For example, the material analysis module 220 may iteratively determine (e.g., calculate, generate, etc.) stress and strain values for the nodes in a graph, as discussed in more detail below. The stress values and/or strain values may indicate whether a material is appropriate for a particular use.

In one embodiment, the material analysis module 220 may determine a set of stress values and/or a set of strain values for the nodes of a graph by selecting a first node from a first set of nodes in the graph. The nodes in the first set of nodes are not associated with stress values and/or strain values. For example, the first set of nodes may be nodes where stress values and/or strain values have not yet been determined, calculated, solved, etc. The material analysis module 220 may select the first node (which does not have a stress value and/or a strain value) and may determine (e.g., calculate, solve, generate, etc.) a stress value and/or a strain value based on determined stress values and determined strain values of other nodes connected to the first set of nodes. For example, material analysis module may determine a stress value and/or a strain value for the first node based on the determined (e.g., known, previously determined, previously calculated, previously solved, etc.) stress values and/or strain values of other nodes that are coupled to the first node. As discussed above, other nodes that are connected to the first node (in the graph) represent finite elements (or portions) of the material structure that are adjacent to the finite element of the material structure represented by the first node.

In one embodiment, the material analysis module 220 may select (e.g., identify) the first node from the first set of nodes by determining a set of percentages for the first set of nodes. For example, for each node in the first set of nodes, the material analysis module 220 may determine a percentage of other nodes coupled to that node which are associated with stress values and/or strain values (e.g., a percentage of nodes coupled to a particular node which have known stress values and/or strain values). After determining a percentage for each of the nodes in the first set of nodes, the material analysis module 220 may identify or select the node with the highest percentage of neighbor nodes with known/solved stress values and/or strain values. If multiple nodes have the same highest percentage, the material analysis module 220 may use other factors, criteria, parameters, etc., to select the first node (from the first set of nodes).

In one embodiment, the material analysis module 220 may select (e.g., identify) the first node from the first set of nodes by determining a set of counts for the first set of nodes. For example, for each node in the first set of nodes, the material analysis module 220 may determine a count of other nodes coupled to that node which are associated with stress values and/or strain values (e.g., a count or number of nodes coupled to a particular node which have known stress values and/or strain values). After determining a count for each of the nodes in the first set of nodes, the material analysis module 220 may identify or select the node with the highest count (e.g., highest number) of neighbor nodes with known/solved stress values and/or strain values. If multiple nodes have the same highest count, the material analysis module 220 may use other factors, criteria, parameters, etc., to select the first node (from the first set of nodes).

In one embodiment, the material analysis module 220 may identify a subset of the set of material structures (e.g., a subset of the material structures) based on the sets of strain values and/or the sets of stress values determined based on the set of graphs. As discussed above, the material analysis module 220 may determine a set of strain values and/or a set of stress values for material structure of the set of material structures. The material analysis module 220 may select, identify, etc., one or more material structures that have stress values and/or strain values that that are above one or more threshold values. The one or more material structures (that are identified/selected) may be referred to as a subset of the material structures.

In one embodiment, the material analysis module 220 may obtain additional sets of stress values and additional sets of strain values for the subset of the material structures. For example, the material analysis module 220 may include and/or may use a finite element analysis (FEA) system, applications, modules, etc., to obtain the additional sets of stress values and additional sets of strain values for the subset of material structures that were previously identified or selected. The FEA system or module may perform a FEA analysis on the subset of material structures and may determine, calculate, generate, etc., an additional set of stress values and an additional set of strain values for each material structure (of the subset of material structures). The additional sets of stress values may be referred to as second sets of stress values and the additional set of strain values may be referred to as second sets of strain values.

In one embodiment, the material analysis module 220 may update the machine learning model (e.g., a neural network) based on the sets of stress values for the set of materials, the sets of strain values for the set of materials, the additional sets of stress values for the subset of materials, and the additional sets of strain values for the subset of materials. For example, the material analysis module 220 may update one or more weights of the machine learning model.

In one embodiment, the material analysis module 220 may compare the additional sets of stress values with the corresponding sets of stress values, and may compare the additional sets of strain values with the corresponding sets of strain values. For example, the material analysis module 220 may select/identify a subset of the material structures, as discussed above. The material analysis module 220 may compare the additional sets of strain values for the subset of material structures (that were determined based on the FEA system/module) with the sets of strain values for the subset of material structures (that were determined based on the machine learning model). The material analysis module 220 may also compare the additional sets of stress values for the subset of material structures (that were determined based on the FEA system/module) with the sets of stress values for the subset of material structures (that were determined based on the machine learning model). If the sets of strain values differ from the additional sets of strain values (e.g., a strain value differs from an additional strain value) by more than a threshold amount, the material analysis module 220 may determine that that the machine learning model should be updated (e.g., the machine learning module should be retrained, the weights of the machine learning model should be updated, etc.).

As discussed above, the material analysis module 220 may include and/or may use a machine learning model to determine stress values and/or strain values for finite elements of a material structure (e.g., for areas or portions of the material structure). The machine learning model may include one or more of a neural network, a graph neural network (GNN), a convolutional neural network (CNN), a recurrent neural network (RNN), a deep neural network (DNN), and a transformer network. Although the present disclosure may refer to neural networks such as a GNN or a DNN, other machine learning models may be used in other embodiments.

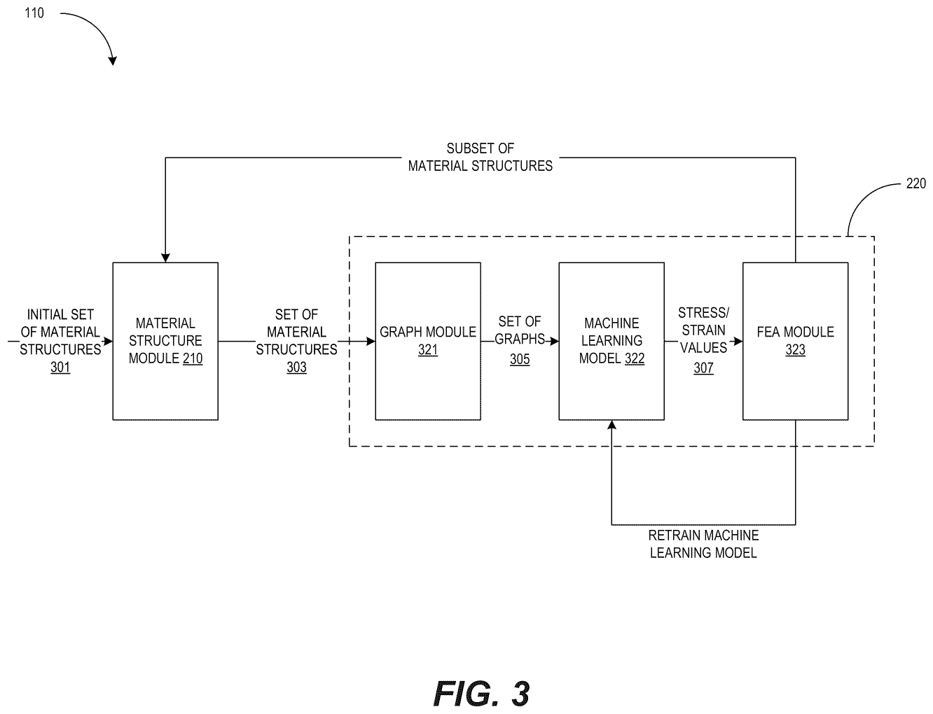

FIG. 3 is a diagram illustrating an example material generation system 110, in accordance with one or more embodiments of the present disclosure. The material generation system 110 includes a material structure module 210 and a material analysis module 220. The material analysis module 220 includes a graph module 321, a machine learning model 322, and an FEA module 323. As discussed above, the material generation system 110 may receive an initial set of material structures 301. For example, the material generation system 110 may receive material structures that were selected/identified by users of the material generation system 110. In another example, the material generation system 110 may receive material structures that were selected/identified based on previous experimentation and finite element analyses. In a further example, the material generation system 110 may receive material structures that were previously generated by the material generation system 110.

The material structure module 210 may generate a set of material structures 303 based on the initial set of material structures 301. For example, the material structure module 210 may add material and/or remove material from one or more of the initial set of material structures 301. The material structure module 210 may add material and/or remove material based on stress values and/or strain values of the initial set of material structures 301, as discussed above. The material structure module 210 may add/remove nodes and/or edges from graphs representing the initial set of material structures 301, as discussed above. In another example, the material structure module 210 may reposition existing nodes in the graphs representing the initial set of material structures 301, as discussed above. The material structure module 210 may provide the set of material structures 303 to the material analysis module 220.

The graph module 321 of the material analysis module 220 may generate a set of graphs 305. For example, the graph module 321 may generate one or more graphs for each of the material structures in the set of material structures. As discussed above, each graph may include nodes which represent finite elements or portions of a material structure. Each graph may also include edges between nodes of the graph, which indicate whether one node (e.g., a finite element or portion of the material structure) is adjacent to another node (e.g., another finite element or another portion of the material structure). The graph module 321 may provide the set of graphs 305 to the machine learning model 322.

As discussed above, the machine learning model 322 may be a GNN, a DNN, a neural network, or some other appropriate machine learning system. The machine learning model 322 may determine (e.g., calculate, generate, solve, etc.) stress values and strain values 307 for the nodes in the set of graphs 305, as discussed in more detail below. For example, the machine learning model 322 may iterate through each node in a graph which is not associated with stress values and/or strain values (e.g., may iterate through each node that does not have a stress and/or strain value) and may determine (e.g., compute, generate, calculate, solve, etc.) the stress value and/or strain value for that node. The machine learning model 322 may provide the stress and/or strain values 307 to the FEA module 323.

The FEA module 323 may select/identify a subset of the graphs (and correspondingly a subset of the material structures) for a finite element analysis. The FEA module 323 may identify one or more materials structures that have stress values and/or strain values that match one or more criteria, conditions, parameters, etc. For example, the FEA module 323 may identify the material structures with the lowest stress values and/or lowest strain values (e.g., materials that may be able to accommodate loads, pressures, forces, etc., while experience lower stress and/or strain).

The FEA module 323 may perform finite element analysis on the subset of materials structures (e.g., material structures with stress values and/or strain values that match various criteria, conditions, etc.). The finite element analysis performed on the subset of material structures may generate additional stress and/or strain values. For example, the finite element analysis may generate an additional set of stress values and an additional set of strain values for each material structure in the subset of material structures.

The FEA module 323 may compare the additional sets of stress values and the additional sets of strain values, with the stress values and strain values 307 generated by the machine learning model 322 (e.g., generated by the GNN, DNN, etc.). If the stress values and the additional sets of stress values differ by more than a threshold and/or if the strain values and the additional sets of strain values differ by more than a threshold, the FEA module 323 may determine that the machine learning model 322 should be updated. For example, the FEA module 323 may retrain the machine learning model 322 (e.g., update one or more weights of the machine learning model 322) based on the additional sets of stress values and the additional sets of strain values. The updated machine learning model 322 may be used to determine stress/strain values of new or other material structures.

The FEA module 323 may also provide the subset of the material structures to the material structure to the material structure module 210. The subset of the material structures may be used as an initial set of material structures that the material structure module 210 may modify (e.g., may add material to, may remove material from etc.) to generate additional sets of materials that may be analyzed by the machine learning model 322 and the FEA module 323. This may allow the material generation system 110 to operate in a loop to continuously generate new material structures with stress and/or strain values that are suitable for various purpose, functions, operations, etc.

In one embodiment, the material generation system 110 may allow users to create possible or candidate material structures that may be used for various applications, more quickly and/or more efficiently. For example, the material generation system 110 may be used to determine the stress values and/or strain values of any number of material structures (e.g., hundreds, thousands, or even millions of different types of material structures). The material generation system 110 may allow users to identify materials that meet threshold criterion for certain material properties. For example, the material generation system 110 may allow users generate material structures that can accommodate, handle, sustain, etc., a certain amount of stress and/or a certain amount of strain.

Although the present disclosure may refer to stress and/or strain as example material properties, various different properties may be determined, obtained, etc., by the material generation system 110. For example, the material generation system 110 may generate material structures with resistance to heat, resistance to cold, wear resistance, etc.

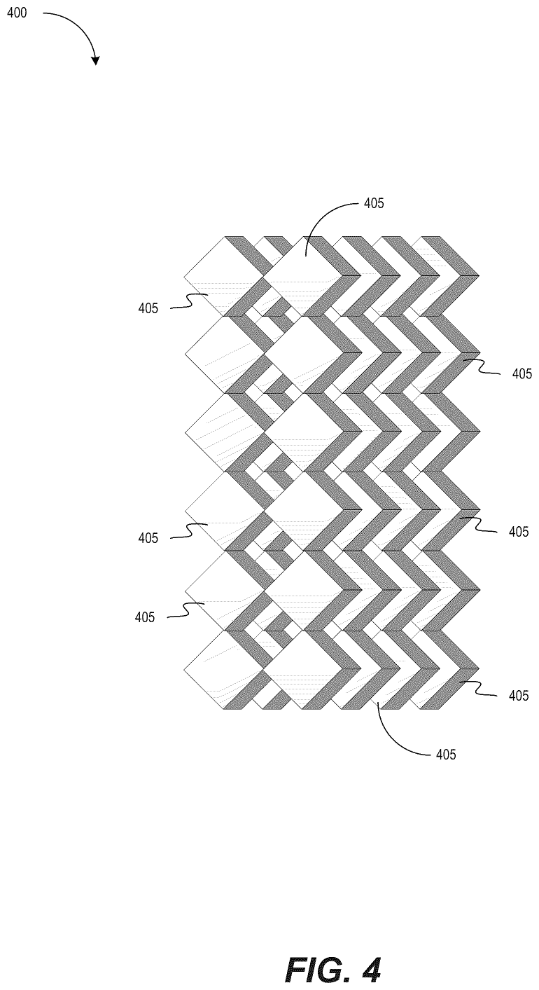

FIG. 4 is a diagram illustrating an example material structure 400, in accordance with one or more embodiments of the present disclosure. As discussed above, the material structure 400 may be the physical structure and/or arrangements of the components of a material (or the components of multiple materials for composite materials). The structure/arrangement of the material structure 400 may determine various material properties of a material. For example, the structure/arrangement of the material structure 400 may determine the amount of stress and/or strain the material is able to accommodate.

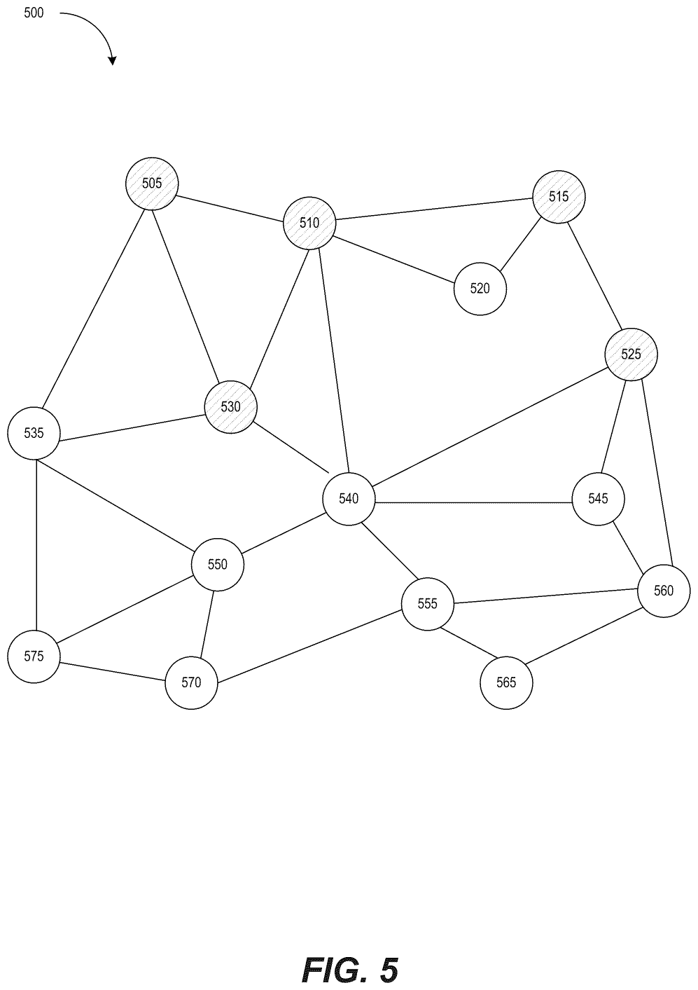

The material structure 400 may be composed of multiple finite elements 405. For simplicity, each finite element 405 is illustrated in FIG. 4 as a cube within the material structure 400. In other embodiments, each cube illustrated in FIG. 4 may represent tens, hundreds, thousands, or even millions of interconnected finite elements. Each finite element 405 is adjacent to one or more other finite elements. As discussed above, the finite elements 405 may be represented using a graph (e.g., graph 500 illustrated in FIG. 5). Each node of the graph may represent a finite element 405 and edges between nodes of the graph may indicate that a finite element is adjacent to another finite element.

FIG. 5 is a diagram illustrating an example graph 500, in accordance with one or more embodiments of the present disclosure. The graph 500 may be used by a material generation system (e.g., material generation system 110) to determine stress values and/or strain values for a material structure. The graph 500 includes nodes 505 through 575 (e.g., includes 15 nodes). The graph 500 may represent the different finite elements of a material structure. For example, the graph 500 may represent the finite elements 405 of the material structure 400 illustrated in FIG. 4. As discussed above, each node of the graph 500 may represent a finite element 405 and edges between a first node and a second node of the graph 500 may indicate that a first finite element 405 is adjacent to a second finite element 405 within the material structure 400.

As discussed above, the graph 500 may be provided to a machine learning model (e.g., a GNN, a DNN, a neural network, etc.) to determine a stress value and/or a strain value for each node in the graph (e.g., for each finite element represented by the nodes 505 through 575). Nodes 505, 510, 515, 525, and 530 may be associated with stress values and/or strain values, as illustrated by the shading of the nodes 505, 510, 515, 525, and 530. For example, stress values and/or strain values may be known, determined, calculated, solved, etc., for the nodes 505, 510, 515, 525, and 530. As discussed above, the stress values and/or strain values for the nodes 505, 510, 515, 525, and 530 to identify a next node and the machine learning model may be used to determine the stress values and/or strain values for the next node. The material generation system may identify a next node (to determine stress/strain values for) based on a percentage or a number/count of neighbor nodes that have known stress/strain values. For example, node 540 may be selected as the next node because node 540 has the highest number of connected nodes with known stress/train values. The machine learning model may determine the stress value and/or strain value for the node 540 based on the stress values and/or strain values for nodes 510, 530, and 525.

The material generation system may iterate through each of the remaining nodes 520 and 535-575 to determine stress values and/or strain values for each of the remaining nodes 520. For example, the material generation system may use the machine learning model to determine stress and/or strain values for node 540, then for node 535, then for node 545, etc., until stress/strain values have been determined for each of the nodes in the graph 500.

In one embodiment, the nodes of the graph 500 may include data (or other information) to indicate the stress values, strain values, and/or location (e.g., XYZ or Cartesian coordinates) of the finite elements represented by the nodes. For example, each node of the graph 500 represents a finite element of a material structure and each node may include one or more of a stress value, a strain value, and a location for a respective finite element. In another embodiment, the stress values, strain values, and/or locations of the finite elements may be in another data structure (e.g., a table, a list, etc.) associated with the graph. For example, the graph 500 may be associated with a table (not illustrated in the figures). The table may include a row for each node and each row may include the stress value, strain value, and location (e.g., XYZ coordinates) for the node (e.g., for the finite element represented by the node).

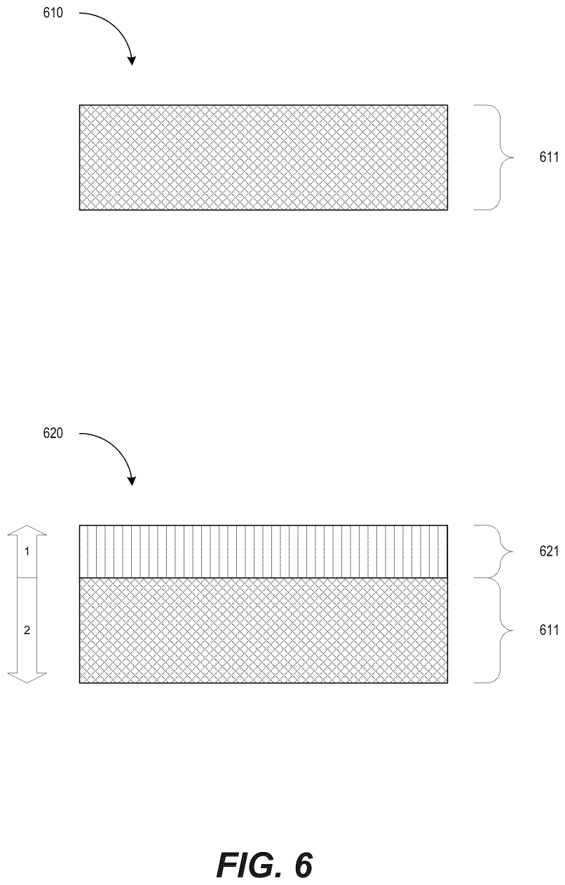

FIG. 6 is a diagram illustrating example material structures 610 and 620, in accordance with one or more embodiments of the present disclosure. As discussed above, the material structures 610 and 620 may include multiple portions/areas or finite elements. Stress values and/or strain values may be determined (e.g., computed, calculated, solved, etc.) for the different portions/areas or finite elements. The material structure 610 may represent a material structure that has known (e.g., determined, predetermined, etc.) stress values and/or strain values. For example, material structure 610 may be an initial material structure that is provided to a material structure module (e.g., material structure module 210). The material structure 610 may include a portion 611. The material structure module may generate additional material structure based on the material structure 610, as discussed above. For example, the material structure module may remove portions/areas from the material structure 610. In another example, illustrated in FIG. 6, the material structure module may add material to the material structure 610.

Material structure 620 may be a material structure that is generated by the material structure module. For example, material structure 620 is generated by adding portion 621 on top of portion 611 (of the material structure 610). The material structure 620 may be provided to a material analysis module 220 to allow the material analysis module 220 to determine stress values and strain values for the material structure 620. As discussed above, the stress values and strain values for the finite elements of portion 611 may be known. The material analysis module 220 may use the known stress/strain values for the portion 611 to determine (e.g., calculate, solve, compute, etc.) the stress/strain values for the portion 621. For example, the material analysis module may start by determining stress/strain values for the portion 621 from the bottom up (as indicated by the arrow labelled “1”). After determining the stress/strain values for the portion 621, the material analysis module may update the stress/strain values for the portion 611 based on the stress/stain values for 621. For example, the material analysis module may start by updating stress/strain values for the portion 611 from the top down (as indicated by the arrow labelled “2”). The stress/strain values for the portion 611 may be updated because adding the portion 621 may affect the stress/strain of the portion 611.

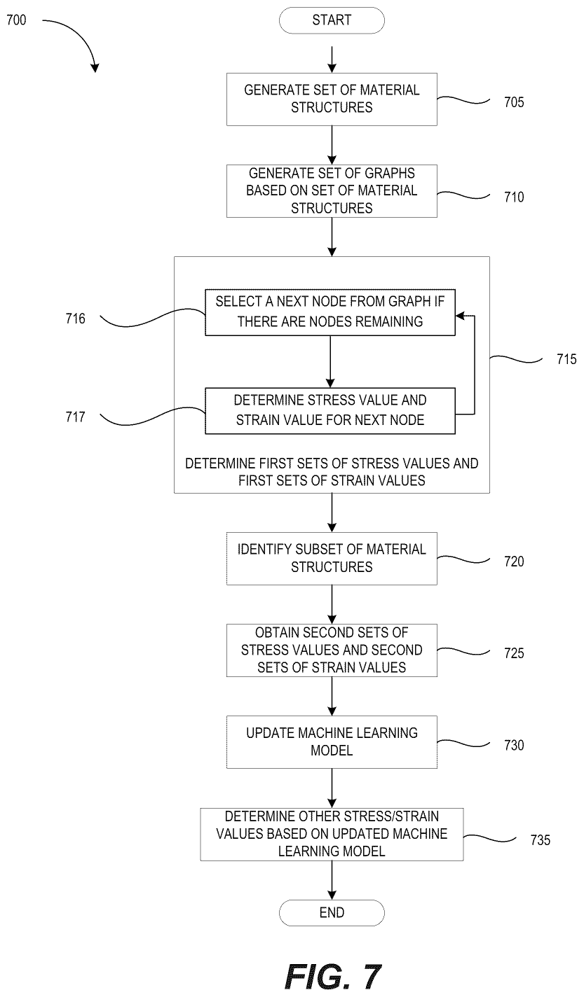

FIG. 7 is a flow diagram of a method 700 for generating material structures in accordance with one or more embodiments of the present disclosure. Method 700 may be performed by processing logic that may comprise hardware (e.g., circuitry, dedicated logic, programmable logic, a field programmable gate array (FPGA), an application specific integrated circuit (ASIC), a processor, a processing device, a central processing unit (CPU), a system-on-chip (SoC), etc.), software (e.g., instructions running/executing on a processing device), firmware (e.g., microcode), or a combination thereof. In some embodiments, the method 700 may be performed by one or more computing devices or computing systems (e.g., the material generation system 110, the material structure module 210, the material analysis module 220, the graph module 321, the machine learning model 322, the FEA module 323, etc., illustrated in FIGS. 1-3).

With reference to FIG. 7, method 700 illustrates example functions used by various embodiments. Although specific function blocks (“blocks”) are disclosed in method 700, such blocks are examples. That is, embodiments are well suited to performing various other blocks or variations of the blocks recited in method 700. It is appreciated that the blocks in method 700 may be performed in an order different than presented, and that not all of the blocks in method 700 may be performed, and other blocks (which may not be included in FIG. 7) may be performed between the blocks illustrated in FIG. 7.

The method 700 begins at block 705 where the method 700 generates a set of material structures. For example, the method 700 may generate the set of material structures by adding and/or remove portions of material from an initial set of material structures. At block 710, the method 700 may generate a set of graphs based on the set of material structures. As discussed above, each graph may represent a material structure. Each graph may also include nodes that represent finite elements and edges that indicate when two finite elements are adjacent to each other.

At block 715, the method 700 may determine first sets of stress values and first sets of strain values for the set of material structures. For example, the method 700 may select a next node from a graph if there are nodes that do not have stress/strain values at block 716. The method 700 may determine the stress value and strain value for the next node (e.g., based on a GNN, a DNN, a neural network, etc. The method 700 may proceed back to 716 until all nodes in all graphs have stress/strain values.

At block 720, the method 700 may identify a subset of the set of material structures. For example, the method 700 may select the material structures that have the lowest stress and/or strain values, or may select material structures that have stress and/or strain values below a threshold. The method 700 may obtain second sets of stress values and second sets of strain values for the subset of material structures. For example, the method 700 may use FEA to analyze the subset of material structures to obtain the second sets of stress values and the second sets of strain values. At block 730, the method 700 may update the machine learning model based on the first and second sets of strain values, and the first and second sets of stress values. At block 735, the method may determine other stress values and other strain values for other material structures based on the updated machine learning model. For example, after the machine learning model is updated, the machine learning model may be used to determine (e.g., calculate) stress/strain values for new material structures that are generated by the material generation system.

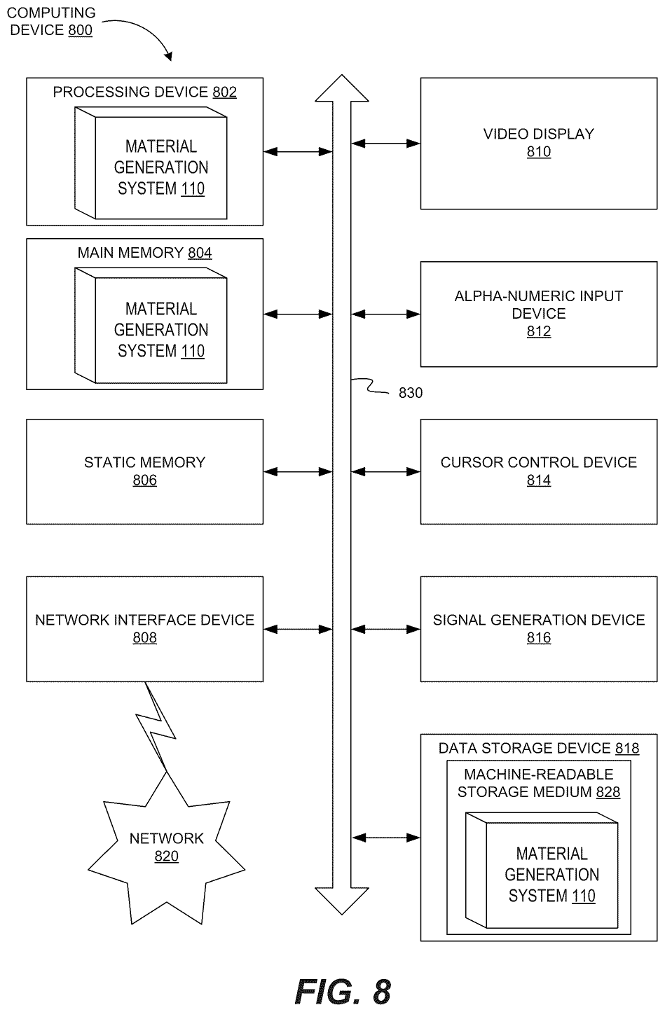

FIG. 8 is a block diagram of an example computing device 800 that may perform one or more of the operations described herein, in accordance with some embodiments. Computing device 800 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 800 may include a processing device (e.g., a general purpose processor, a PLD, etc.) 802, a main memory 804 (e.g., synchronous dynamic random access memory (DRAM), read-only memory (ROM)), a static memory 806 (e.g., flash memory and a data storage device 818), which may communicate with each other via a bus 830.

Processing device 802 may be provided by one or more general-purpose processing devices such as a microprocessor, central processing unit, or the like. In an illustrative example, processing device 802 may comprise a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also comprise one or more special-purpose processing devices such as an application specific integrated circuit (ASIC), a field programmable gate array (FPGA), a digital signal processor (DSP), network processor, or the like. The processing device 802 may be configured to execute the operations described herein, in accordance with one or more aspects of the present disclosure, for performing the operations and steps discussed herein.

Computing device 800 may further include a network interface device 808 which may communicate with a network 820. The computing device 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and an acoustic signal generation device 816 (e.g., a speaker). In one embodiment, video display unit 810, alphanumeric input device 812, and cursor control device 814 may be combined into a single component or device (e.g., an LCD touch screen).

Data storage device 818 may include a computer-readable storage medium 828 on which may be stored one or more sets of instructions, e.g., instructions for carrying out the operations described herein, in accordance with one or more aspects of the present disclosure. Instructions implementing the different systems described herein (e.g., the material generation system 110, the material structure module 210, the material analysis module 220, the graph module 321, the machine learning model 322, the FEA module 323, etc., illustrated in FIGS. 1-3) may also reside, completely or at least partially, within main memory 804 and/or within processing device 802 during execution thereof by computing device 800, main memory 804 and processing device 802 also constituting computer-readable media. The instructions may further be transmitted or received over a network 820 via network interface device 808.

While computer-readable storage medium 828 is shown in an illustrative example to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Unless specifically stated otherwise, terms such as “generating,” “determining,” “obtaining,” “updating,” “removing,” “adding,” “selecting,” “performing,” “identifying,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general purpose computing device selectively programmed by a computer program stored in the computing device. Such a computer program may be stored in a computer-readable non-transitory storage medium.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

When an action, function, operation, etc., is described herein as being performed automatically, this may indicate that the action, function, operation, etc., may be performed without requiring human or user input, invocation, or interaction.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware—for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method, comprising:
obtaining a set of graphs for a set of material structures, wherein:
each graph of the set of graphs is associated with a material structure of the set of material structures;
each graph comprises nodes representing finite elements of a corresponding material structure;
determining first sets of stress values and first sets of strain values for the set of graphs based on a machine learning model;
obtaining second sets of stress value and second sets of strain values for a subset of the set of material structures;
updating the machine learning model based on the first sets of stress values, the first sets of strain values, the second sets of stress values, and the second sets of strain values; and
determining other stress values and other strain values for other material structures based on the updated machine learning model.

2. The method of claim 1, further comprising:
generating the set of material structures based on an initial set of material structures wherein generating the set of material structures based on the initial set of material structures comprises one or more of:
removing material from the initial set of material structures; and
adding material to the initial set of material structures.

3. The method of claim 2, wherein removing material from the initial set of material structures comprises:
removing material from areas of the set of material structures with stress values below a threshold stress value and strain values below a threshold strain value.

4. The method of claim 2, wherein adding material to the initial set of material structures comprises:
adding material to areas of the set of material structures with stress values above a threshold stress value and strain values above a threshold strain value.

5. The method of claim 1, wherein determining the set of stress values and the set of strain values comprises:
selecting a first node from a first set of nodes of a first graph based on determined stress values and determined strain values of other nodes connected to the first set of nodes, wherein the first set of nodes are not associated with stress values and strain values.

6. The method of claim 5, wherein selecting the first node comprises:
determining a set of percentages for the first set of nodes, wherein each percentage indicates a percentage of neighbor nodes with determined stress values and determined strain values for a respective node of the first set of nodes;
selecting the first node based on a highest percentage of the set of the set of percentages.

7. The method of claim 5, wherein selecting the first node comprises:
determining a set of counts for the first set of nodes, wherein each count indicates a number of neighbor nodes with determined stress values and determined strain values for a respective node of the first set of nodes;
selecting the first node based on a highest count of the set of the set of counts.

8. The method of claim 1, wherein obtaining the second sets of stress value and the second sets of strain values for the subset of the set of material structures comprises:
performing finite element analyses for the subset of the set of material structures to obtain the second sets of stress value and the second sets of strain values.

9. The method of claim 1, further comprising:
identifying the subset of the set of material structures based on the first sets of stress values and the first sets of strain values.

10. The method of claim 1, wherein the machine learning model comprises one or more of a graph neural network, a recurrent neural network, a convolutional neural network, and a deep neural network.

11. An apparatus, comprising:
a memory configured to store data; and
a processing device coupled to the memory, the processing device configured to:
obtaining a set of graphs for a set of material structures, wherein:
each graph of the set of graphs is associated with a material structure of the set of material structures;
each graph comprises nodes representing finite elements of a corresponding material structure;
determine first sets of stress values and first sets of strain values for the set of graphs based on a machine learning model;
obtain second sets of stress value and second sets of strain values for a subset of the set of material structures;
update the machine learning model based on the first sets of stress values, the first sets of strain values, the second sets of stress values, and the second sets of strain values;
determining other stress values and other strain values for other material structures based on the updated machine learning model.

12. The apparatus of claim 1, wherein the processing device is further to:
generate the set of material structures based on an initial set of material structures wherein to generating the set of material structures based on the initial set of material structures comprises one or more of:
removing material from the initial set of material structures; and
adding material to the initial set of material structures.

13. The apparatus of claim 2, wherein to remove material from the initial set of material structures the processing device is to:
remove material from areas of the set of material structures with stress values below a threshold stress value and strain values below a threshold strain value.

14. The apparatus of claim 2, wherein to add material to the initial set of material structures the processing device is to:
add material to areas of the set of material structures with stress values above a threshold stress value and strain values above a threshold strain value.

15. The apparatus of claim 1, wherein to determine the set of stress values and the set of strain values the processing device is to:
select a first node from a first set of nodes of a first graph based on determined stress values and determined strain values of other nodes connected to the first set of nodes, wherein the first set of nodes are not associated with stress values and strain values.

16. The apparatus of claim 5, wherein to select the first node the processing device is to:
determine a set of percentages for the first set of nodes, wherein each percentage indicates a percentage of neighbor nodes with determined stress values and determined strain values for a respective node of the first set of nodes;
select the first node based on a highest percentage of the set of the set of percentages.

17. The apparatus of claim 5, wherein to select the first node the processing device is to:
determine a set of counts for the first set of nodes, wherein each count indicates a number of neighbor nodes with determined stress values and determined strain values for a respective node of the first set of nodes;
select the first node based on a highest count of the set of the set of counts.

18. The apparatus of claim 1, wherein to obtain the second sets of stress value and the second sets of strain values for the subset of the set of material structures the processing device is to:
perform finite element analyses for the subset of the set of material structures to obtain the second sets of stress value and the second sets of strain values.

19. The apparatus of claim 1, wherein the processing device is further to:
identify the subset of the set of material structures based on the first sets of stress values and the first sets of strain values.

20. A non-transitory computer-readable storage medium including instructions that, when executed by a processing device, cause the processing device to perform operations comprising:
obtain a set of graphs for a set of material structures, wherein:
each graph of the set of graphs is associated with a material structure of the set of material structures;
each graph comprises nodes representing finite elements of a corresponding material structure;
determine first sets of stress values and first sets of strain values for the set of graphs based on a machine learning model;
obtain second sets of stress value and second sets of strain values for a subset of the set of material structures;
update the machine learning model based on the first sets of stress values, the first sets of strain values, the second sets of stress values, and the second sets of strain values; and
determining other stress values and other strain values for other material structures based on the updated machine learning model.
